(19) United States
(12) Patent Application Publication
(10) Pub. No.: US 2005/0111901 A1
(43) Pub. Date: May 26, 2005

(54) Fluid cosmetic product dispenser

(75) Inventor: Alberto Tintore Belil, Barcelona (ES)

Correspondence Address: Ira J. Schultz;DENNISON, SCHULTZ, DOUGHERTY & MACDONALD, Suite 105, 1727 King Street, Alexandria, VA, 22314-2700, US

(73) Assignee: Industrias Metalicas Castello S.A.

(21) Appl. No.: 10/967,637

(22) Filed: Oct. 19, 2004

(30) Foreign Application Priority Data
Oct. 20, 2003 (FR) PV 200302435

(51) Int. Cl. B43K 5/06; F16B 35/02

(52) U.S. Cl. 401/176

(57) ABSTRACT

The dispenser includes a longitudinal container provided with a lateral wall having an axial direction and an opening in its upper part forming a neck, an application head, a typically threaded axial rod engaging with a piston, and a cap. It is characterised in that the rod is a hollow rod forming an axial shaft ensuring a flow of the product from the bottom of the container up to the application head, and the axial rod engages in rotation with the application head. Rotating the application head relative to the container brings about a displacement of the piston towards the bottom of the container. The mechanism for propelling the product has a small space requirement and is partly housed in the application head.

### TECHNICAL FIELD

The present invention relates to the field of cosmetic product dispensers, particularly those for fluid or liquid cosmetic products, and more especially those for cosmetic products for application to the lips, particularly lipsticks.

### THE PRIOR ART

Traditionally, cosmetic products used as lipsticks form solid products, usually housed in a tube in the form of a stick known in French as a “raisin”, which are applied to the lips like a brush, which causes a more or less large quantity of lipstick to be deposited depending on the pressure exerted on the tube.

These lipstick tubes comprise a mechanism for displacing the stick manually. This mechanism habitually comprises, from the inside to the outside, a stick holder provided with two diametrically opposed radial lugs, a central tube provided with two axial grooves and a concentric outer tube provided on its inner surface with a helical groove, the two lugs passing through the two axial grooves and being guided by the helical grooves, in such a way that a relative rotation of the central tube relative to the concentric outer tube brings about an axial displacement of the holder and therefore of the stick.

More recently dispensers have appeared for lipsticks in the form of fluid products.

In this way, French patent no. 2 727 608 describes a dispenser that comprises, as a means of application, a head with orifices provided with valves, and as a means of propulsion, an assembly formed by a piston and a screw integral with the bottom of the dispenser, the bottom forming a component distinct from the body of the dispenser, such that rotating the bottom displaces the piston towards the head, brings about a compression of the fluid product and opens the valves and causes the product to flow through the orifices of the head.

Also known is French patent no. 2 727 609 wherein the means of propulsion comprises a manual axial movement of a piston, by means of an axial slit formed in the body of the dispenser.

### PROBLEMS POSED

The problems posed arise from the multiplicity of constraints that have to be overcome to obtain a commercially viable dispenser.

On the one hand, it is important to have dispensers that are straightforward or inexpensive to manufacture by assembling the component parts at the manufacturers, and easy to fill for the packer of cosmetic products, and typically of lipsticks.

On the other hand, it is appropriate also to have dispensers wherein the mechanism for propelling the cosmetic product occupies, relative to the volume of packed cosmetic product, a relatively small space or height in the dispenser, so as to have a dispenser that has a reasonable height/capacity ratio. Indeed, the very application to the lips requires the dispenser or application means to have a diameter similar to that of traditional dispensers, with the result that the capacity of the dispenser cannot be increased by increasing the diameter of the dispenser.

Additionally, given the fluidity of the packed lipsticks, it is important to be sure that there will be no inadvertent discharge of the fluid lipstick, when a tube of lipstick is put into a pocket or a handbag, which could be catastrophic, given the colouring power of a lipstick.

Furthermore, it is important that the dispenser is sealed so that there is no risk of the lipstick compound drying up.

Moreover, given the fluidity of the lipstick compound, it may be advantageous or necessary for any application of lipstick to be accompanied by a blending or a shearing of the lipstick so as to homogenise its compound, since the risk of the constituents of the compound separating increase with its fluidity.

Finally, it is desirable for fluid lipstick dispensers to have a form of presentation that is similar to that of traditional lipstick tubes, so that users of traditional dispensers are already familiar with fluid lipstick dispensers.

### DESCRIPTION OF THE INVENTION

The fluid cosmetic product dispenser, intended particularly for the packing of cosmetic products to be applied to the lips, comprises a body forming a longitudinal container intended to contain said product and comprising a lateral wall of constant internal cross-section having an axial direction and an opening in its upper part typically forming a neck, an application head closing up said upper opening able to apply said product, a typically threaded axial rod engaging with a piston able to be moved axially in said container by rotation of said rod, and a cap to cover said application head when said dispenser is said to be closed.

It is characterised in that:
a) said rod is a hollow rod which forms an axial shaft allowing said product to flow from the bottom of said container up to said application head, said hollow rod emerging through an upper orifice at its upper end onto said application head,
b) said axial rod engages in rotation with said application head,
in such a way that a relative manual rotation of said application head relative to the container brings about a displacement of said piston towards the bottom of said container, compresses said fluid cosmetic product and allows it to flow in said axial shaft up to said application head so that said application head is supplied with cosmetic product, and so as to have a mechanism for propelling said product that has a small space requirement and is partly housed in said application head.

These means of the invention resolve the problems posed.

Indeed, the fluid cosmetic product dispenser according to the invention is a longitudinal compact dispenser, similar to tubes of lipstick, both functionally and with regard to the body movements associated with the application of lipstick. In this dispenser, with external dimensions similar to those of a traditional tube of lipstick, the mechanism for propelling the cosmetic product is hidden in the upper part of the dispenser forming the application head, the dispenser container being able to be of a transparent material in such a way that the shade of the packaged lipstick appears clearly to the user.

Additionally, the dispenser according to the invention allows said product to flow in an axial tube, prior to application, which causes the different constituents of said products to shear, blend and homogenise, since the risks of sedimentation or separation of the constituents may increase with the fluidity of the compound of said cosmetic product.

Furthermore, as will appear in what follows, the dispenser according to the invention is adapted to the embodiment of a large number of variants, as regards both the propulsion mechanism, the structure of the application head or the very nature of the application materials intended to come into contact with the lips or any other part of the face or body.

Typically these dispensers are easy to fill: the container is first of all filled with said product, then by snapping it on axially, said container is closed up by an assembly comprising the application head with said axial rod carrying said piston, said cap preferably interlocking with said application head, said assembly being itself formed typically by being axially snapped together. Indeed, even the piston and the typically threaded axial rod can be assembled by a relative axial movement, since the threading of the rod and the piston allows, through its orientation, the piston to be assembled with the axial rod without having to use a relative rotation movement that is much longer to implement on an industrial production line.

These dispenser embodiment variants may comprise a variable number of components, and some of these variants may comprise a very restricted number of components. Additionally, the dispenser according to the invention makes it possible in particular to package any type of fluid cosmetic product compound, even those including relatively volatile products, since the container of said dispenser comprises a neck able to be assembled to said dispensing head in a sealed way, said container being able to be made out of or comprise any plastic thermoplastic material that forms a barrier adapted to the content, said container being able to comprise a multi-layer material.

### DESCRIPTION OF THE FIGURES

FIGS. 1a to 1k are axial cross-sections of dispensers (1) according to different methods of implementation of the invention. All these dispensers (1) comprised a longitudinal container (2) having an axial direction (10) and provided with a neck (20) closed up by an application head (3) integral with a threaded axial rod (4) and a piston (5), and covered by a cap (11), said dispensers (1) being shown closed.

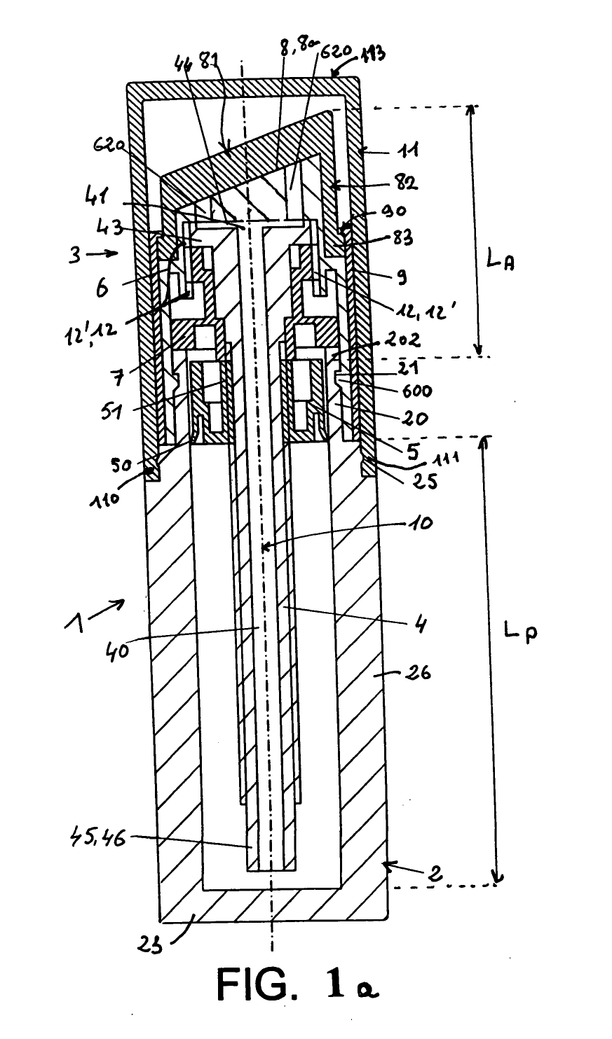

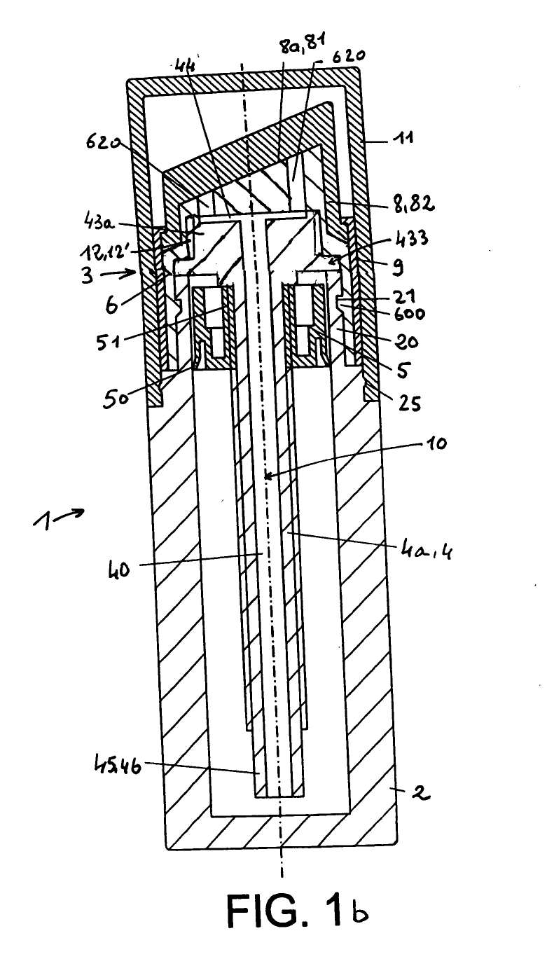

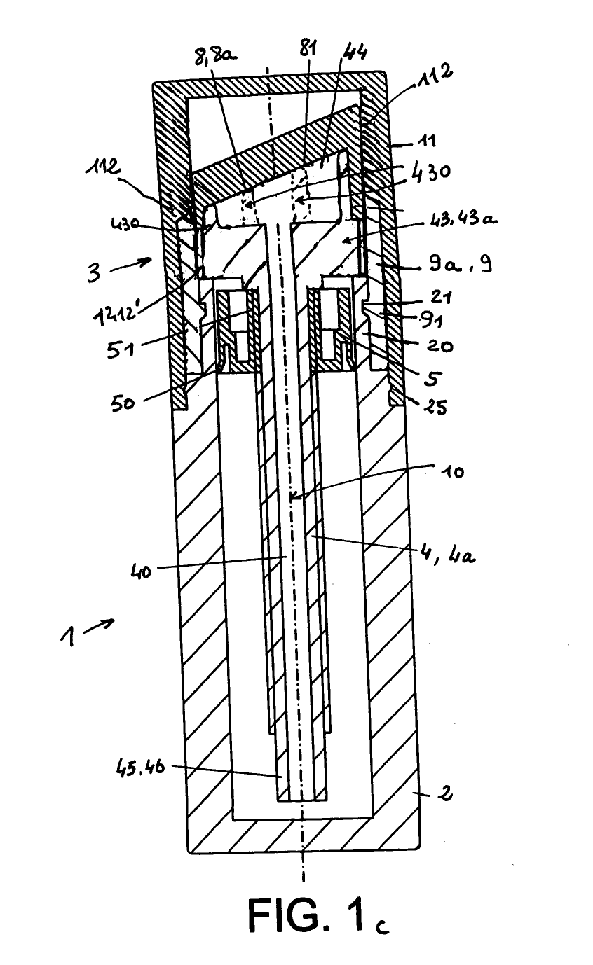

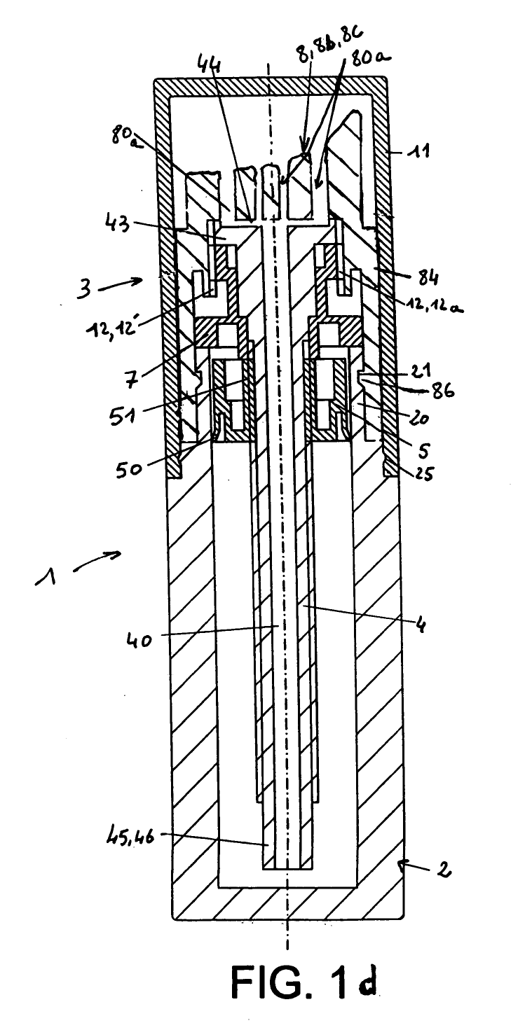

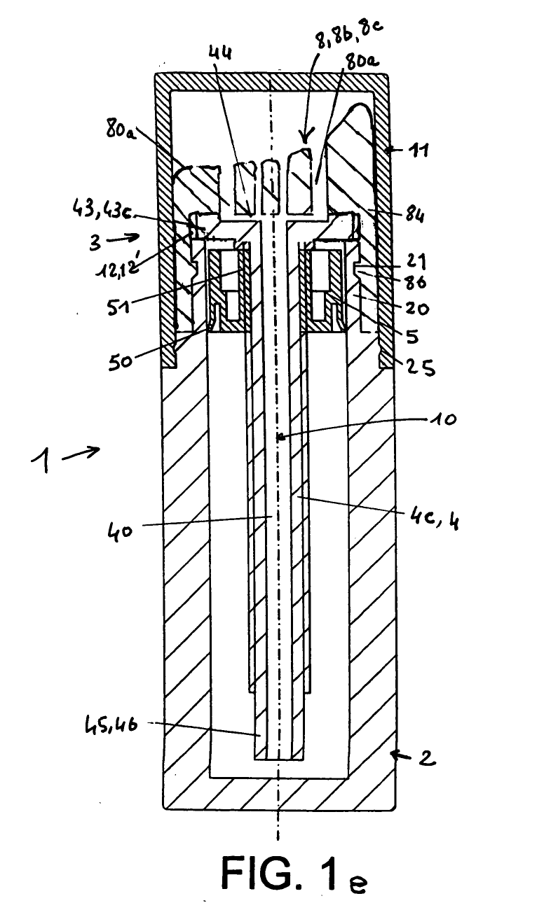

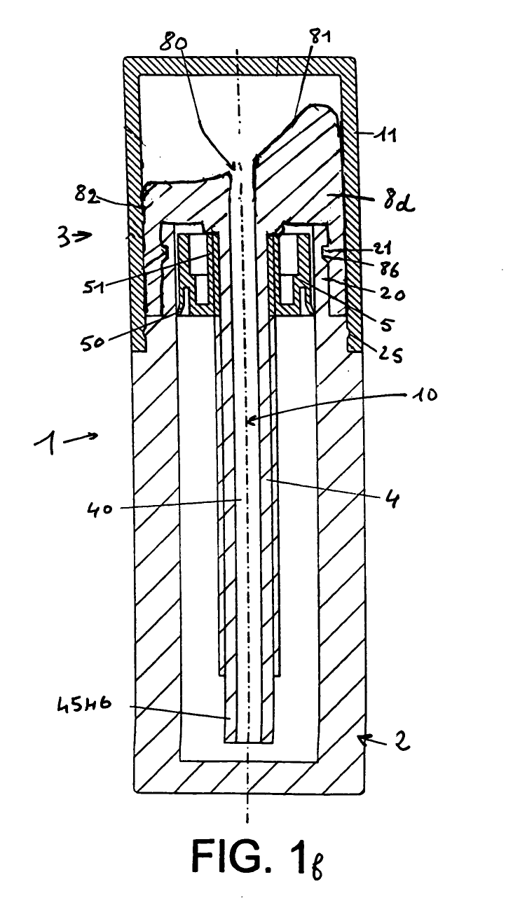

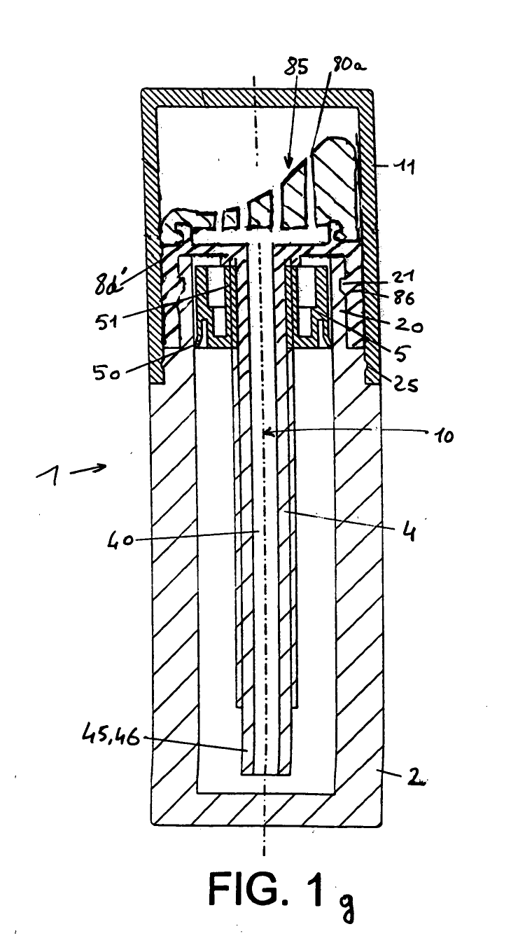

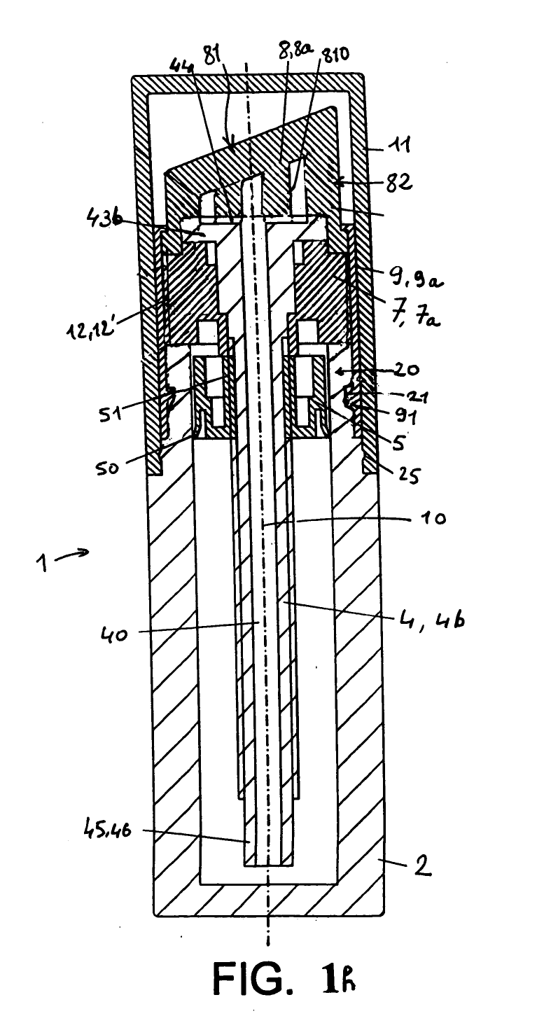

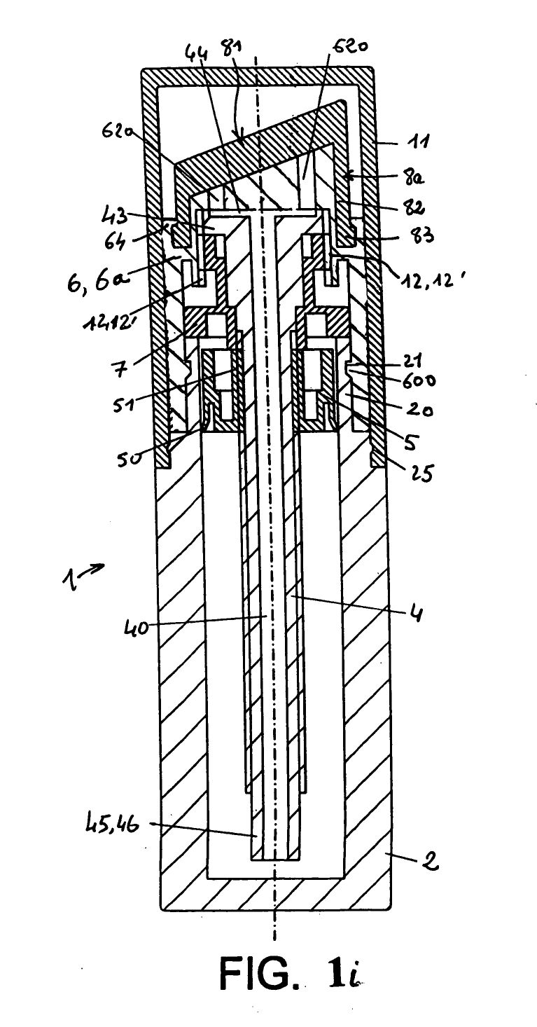

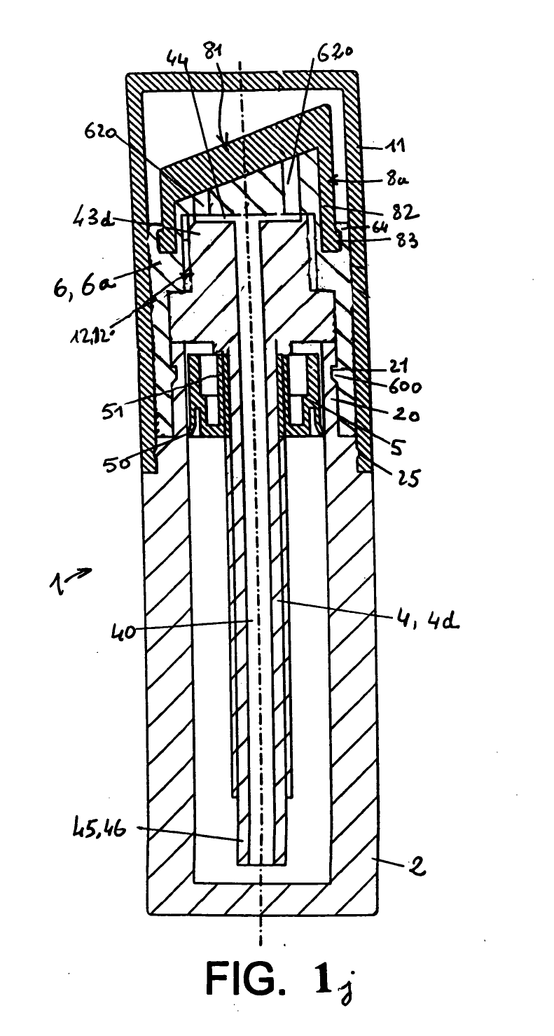

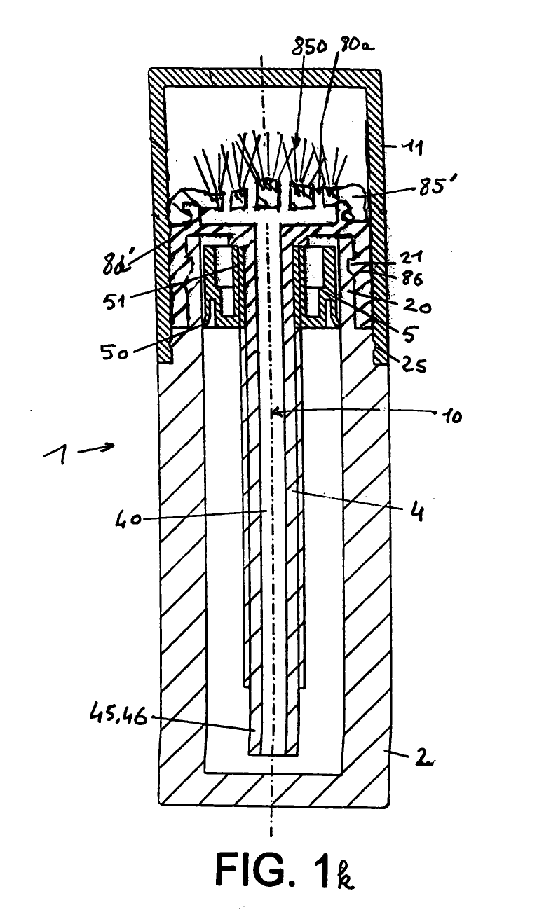

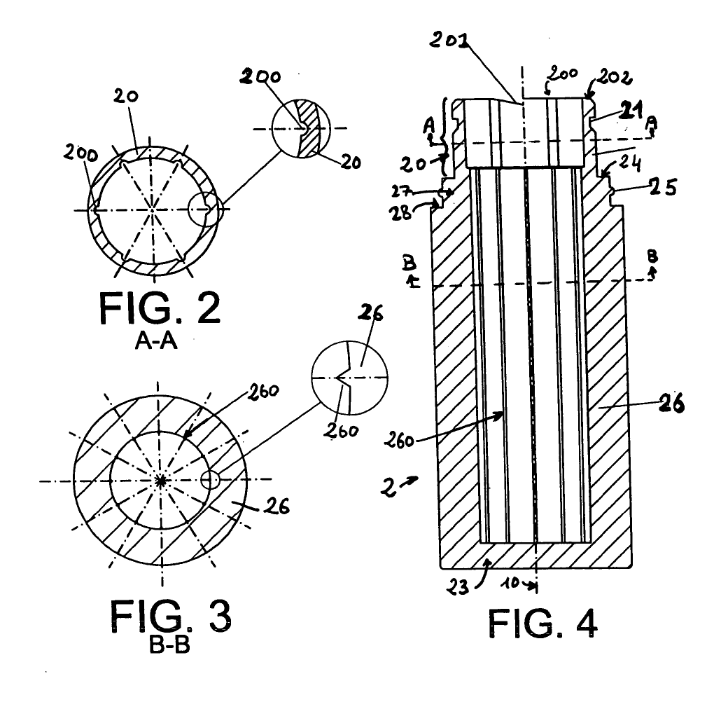

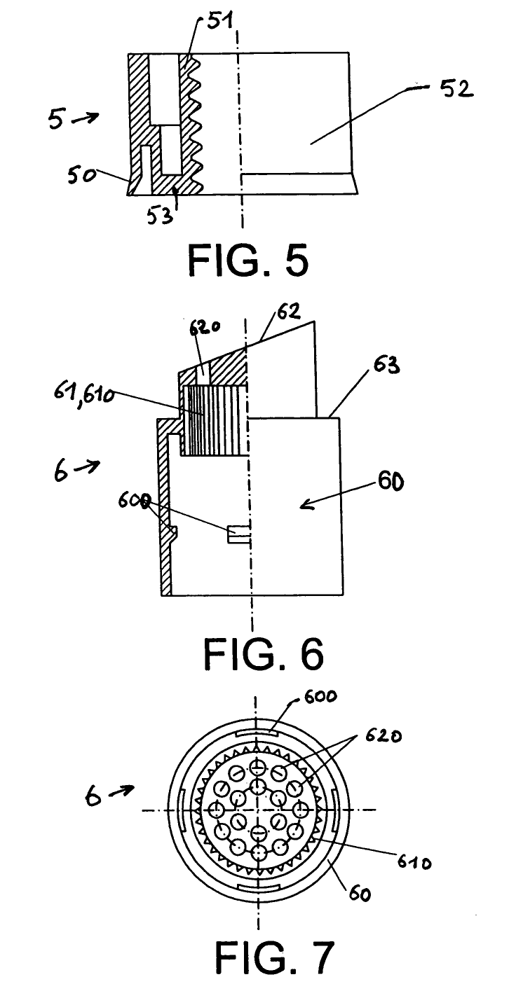

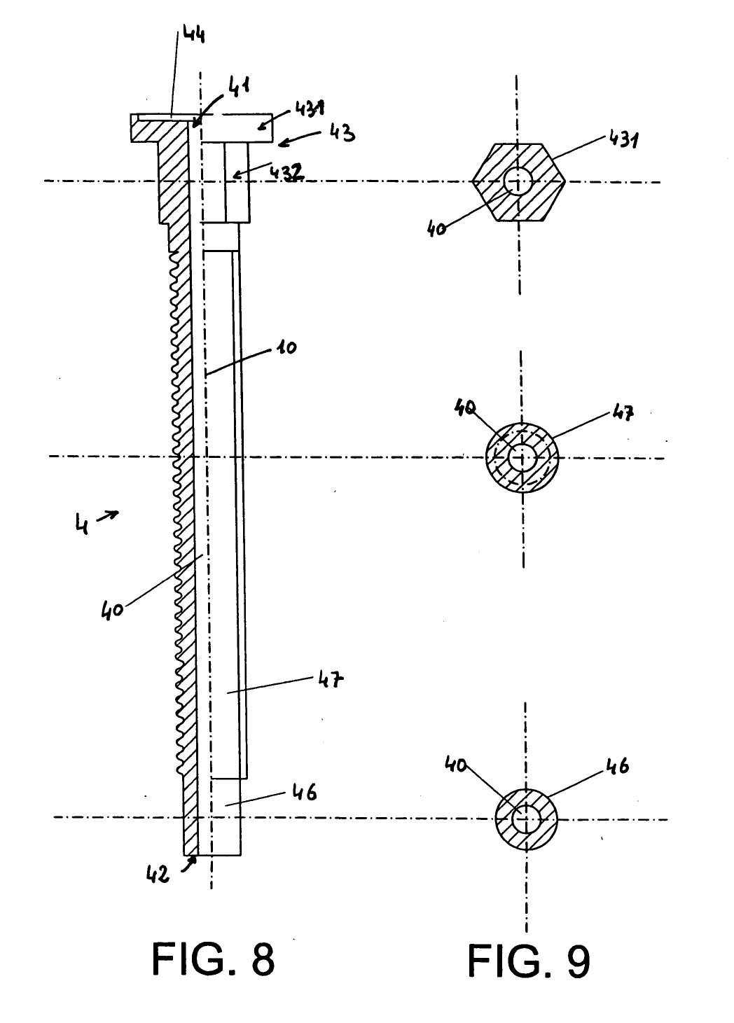

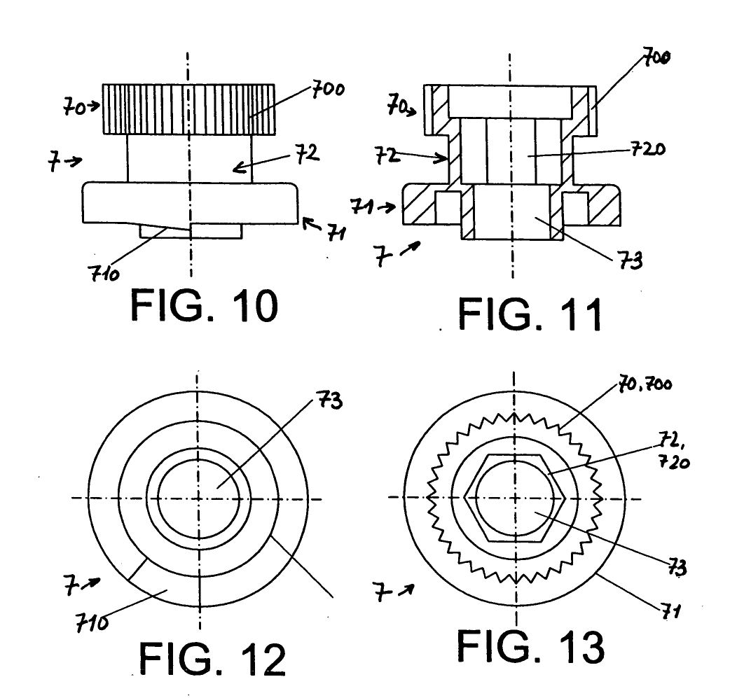

The application head (3) of the dispenser (1) in FIG. 1a comprises: an outer assembly component (6), an inner centring component (7), an applicator (8) comprising a component (8a) of a porous, alveolar or fibrous material, and a bush (9) for assembling said applicator (8a).

The application head (3) of the dispenser (1) in FIG. 1b can be distinguished from that in FIG. 1a by the fact that said rod (4) is a rod (4a) comprising a head (43a) that centres said rod, so as to be able to eliminate said inner centring component (7).

The application head (3) of the dispenser (1) in FIG. 1c can be distinguished from that in FIG. 1b by the fact that said assembly bush (9) is an assembly bush (9a) able to interlock said application head (3) with said neck (20) of said container (2), so as to be able to eliminate said outer assembly component (6).

The application head (3) of the dispenser (1) in FIG. 1d can be distinguished from that in FIG. 1a by the fact that, on the one hand, said applicator (8) forms a component (8b) moulded out of a plastic material provided with a plurality of orifices (80a), and by the fact that on the other hand said moulded component (8b) is a moulded component (8c) comprising a skirt (84) that interlocks said moulded component (8c) with said neck (20), so as to be able to eliminate said outer assembly component (6) and said assembly bush (9).

The application head (3) of the dispenser (1) in FIG. 1e can be distinguished from that in FIG. 1d by the fact that said axial rod (4) is a rod (4c) comprising a head (43c) that centres said rod, so as to be able to eliminate said inner centring component (7).

The application head (3) of the dispenser (1) in FIG. 1f can be distinguished from that in FIG. 1e by the fact that said moulded component (8c) forms with said rod (4) a component (8d) cast in one piece and provided with an orifice (80).

The application head (3) of the dispenser (1) in FIG. 1g can be distinguished from that in FIG. 1f by the fact that said moulded component (8d) is a moulded component (8d′) engaging, typically by being snapped on, with an application insert (85) comprising said plurality of orifices (80a).

The application head (3) of the dispenser (1) in FIG. 1h can be distinguished from that in FIG. 1a by the fact that, on the one hand, said inner centring component (7) is an inner centring component (7a), by the fact that, on the other hand, said applicator (8) or said typically inclined application portion (81) of said applicator (8) comprises axial projections (810) acting as a stop against the head (43, 43b) of said rod (4), and by the fact that lastly said assembly bush (9) is a bush (9a) that interlocks said application head (3) with said neck (20).

The application head (3) of the dispenser (1) in FIG. 1i can be distinguished from that in FIG. 1a by the fact that said as outer assembly component (6) is an outer assembly component (6a) that interlocks said applicator (8) with said application header (3), so as to be able to eliminate said assembly bush (9).

The application head (3) of the dispenser (1) in FIG. 1j can be distinguished from that in FIG. 1i by the fact that said rod (4) is a rod (4d) comprising a head (43d) that centres said rod, so as to be able to eliminate said inner centring component (7).

The application head (3) of the dispenser (1) in FIG. 1k can be distinguished from that in FIG. 1g by the fact that said application insert (85) comprising said plurality of orifices (80a) is an insert (85′) acting as a holder for a plurality of hairs (850), so as to form a brush.

FIGS. 2 to 13 relate to the dispenser (1) according to FIG. 1a in particular.

FIGS. 2 to 4 relate to the container (2).

FIG. 2 is a transverse cross-section view of the neck (20) of the container (2).

FIG. 3 is a transverse cross-section view of the lateral wall (26) of the container (2).

FIG. 4 is an axial cross-section view of the container (2).

FIG. 5 shows the piston (5), in axial cross-section over its left half-part, and in a side view over its right half-part.

FIG. 6 shows the outer assembly component (6), in axial cross-section over its left half-part, and in a side view over its right half-part.

FIG. 7 is a view from underneath of the outer assembly component (6) in FIG. 6.

FIGS. 8 and 9 show the axial rod (4).

FIG. 8 is an axial cross-section of the left half-part of the figure and a side view of the right half-part of the figure.

The different parts of FIG. 9 are transverse cross-sections at different heights of the axial rod (4).

FIGS. 10 to 13 show the inner centring component (7) which transmits the rotation movement of said outer assembly component (6) to the head (43) of said axial rod (4).

FIG. 10 is a side view.

FIG. 11 is an axial cross-section view.

FIG. 12 is a view from under.

FIG. 13 is a view from above.

### DETAILED DESCRIPTION OF THE INVENTION

According to one embodiment of the invention shown particularly in FIG. 1a and in FIGS. 2 to 12, said application head (3) may comprise:
a) an outer part (6) for assembly with said container, typically able to engage said rod (4) in rotation,
b) an inner part (7) for centring said rod (4),
c) an applicator (8) closing up said upper orifice (41) of said rod (4)
d) a bush (9) for assembling said applicator (8) with said outer part (6), in such a way that said manual rotation applied to said bush (9) engages that of said rod (4).

In this embodiment, as shown for example in FIG. 4, said neck (20) of said container (2) may comprise a circular groove (21) providing an axial coupling of said outer part (6), or of said applicator (8), or of said bush (9) of said application head (3) with said neck (2), said outer part (6), or said applicator (8), or said bush (9) comprising a plurality of inner projections, denoted respectively (600), (86) (91), intended to be snapped into said circular groove (21). It is a means for axially snapping said application head (3) into said neck (20).

As shown in FIG. 6, said outer component (6) may comprise a part of internally ribbed cross-section (61) engaging in rotation along said axial direction (10) with a part of externally ribbed cross-section (70) of said centring component (7), as shown in FIG. 10.

In other embodiments of the invention, said outer components (6) may engage in rotation directly with the head (43) of said axial rod (4), as shown in FIGS. 1b and 1j, said centring component (7) having been eliminated, the head (43) of said axial rod (4) having been modified so as to be able to fulfil the function of said centring component (7).

In this way, generally, said application head (3) may typically comprise two coaxial parts provided with rotation engaging projections (12, 12′) in such a way that the rotary motion applied to the outermost part is transmitted to the innermost part, and in 20 such a way that these parts are able to be assembled by axial assembly. This concerns the parts identified as (6) and (7) in FIG. 1a, the parts identified as (6) and (4a) in FIG. 1b, the parts identified as (9a) and (4a) in FIG. 1c, the parts identified as (7) and (8) in FIG. 1d, the parts identified as (4c) and (8) in FIG. 1e, the parts identified as (7a) and (9a) in FIG. 1h, the parts identified as (6a) and (7) in FIG. 1i, the parts identified as (6a) and (4d) in FIG. 1j.

As shown in FIGS. 4 and 10, said centring component (7) may comprise on its lower part (71) a tooth or non-return notch (710) intended to engage with a notch (22) formed on the opening of said container (2), in such a way that said application head (3) is only able to rotate relative to said container (2) in the sole direction of rotation that allows the piston (5) to descend in said container (2).

However, when, in some embodiments of the invention, said centring component (7) is eliminated, as indicated previously, it is the head (43) which is able to carry a tooth or anti-rotation notch intended to engage with a notch (22) formed on the opening of said container (2).

As shown particularly in FIGS. 9 and 13, said centring component (7) may comprise a median part (72) of polygonal internal cross-section (720), said threaded rod (4) being provided with a head (43) comprising a part of identical polygonal cross-section, so as to interlock said threaded rod (4) in rotation with said centring component (7).

As shown particularly in FIG. 6, said assembly component (6) may have a tubular configuration with an upper arch (62) provided with a plurality of orifices (620) communicating with said applicator (8), said threaded rod (4) comprising a hollowed out upper part (44), in such a way that said cosmetic product is able to flow to the outlet of said axial shaft (40) as far as said plurality of orifices (620).

As shown in FIGS. 1a to 1j, said threaded rod (4) may have a sufficient distance between its lower end (45) and the bottom (23) of said container (2) to bring the inside of said container (2) and the inside of said axial shaft (40) into communication.

Said threaded rod (4) may comprise at its lower end (45) a non-threaded part (46), so as to prevent said piston (5) from being compressed against said bottom (23) of said container (2).

As shown in FIGS. 3 and 4, said container (2) may comprise an anti-rotation means for said piston (5) typically formed by a plurality of axial ribs (260) formed on the inner surface of said wall (26) of said container (2), engaging with said piston (5), so as to interlock said container (2) and said piston (5) in rotation.

As shown in FIG. 5, said piston (5) may comprise a flexible peripheral lip (50) so as to provide a sealed joint with the inner surface of said container (2), said inner surface being typically provided with said axial ribs (260).

As shown in FIGS. 2 and 4, said neck (20) may comprise on its inner surface a plurality of axial grooves (200) so as to provide an evacuation of air during an assembly of said application head (3) or of said mechanism with said container (2) previously filled with said cosmetic product, said piston (5) having previously been screwed to said threaded rod (4).

As shown in FIGS. 1a to 1k, said applicator (8) may comprise a typically 20 inclined upper part or application portion (81) forming a surface for the application of said cosmetic product and a lateral part or straight portion (82) possibly comprising a lower assembly flange (83), in such a way that said applicator (8) is integral with said application head (3), for example, by means of a reflex flange (90) of said assembly bush (9).

However since the applicator (8) according to the invention is not exclusively intended to form a lipstick applicator, the upper part of the applicator intended to come into contact with a holder, in other words with a part of the face or human body, may have a shape or a curve adapted to this precise application, the curve being able to be complex instead of concave, and form an inclined or non-inclined median plane, a non-inclined plane being a plane perpendicular to said axial direction (10).

According to one embodiment of the invention shown in FIGS. 1a, 1b, 1c, 1h, 1i and 1j, said applicator (8) may form a separate component (8a) in a porous or fibrous or alveolar material with open alveoli, for example foam. This separate component (8a) may have a certain axial elasticity and present itself in the form of a pad, a block of foam that is soft to the touch and allows said cosmetic product to pass through its pores, so as to make for easy application.

It can however have sufficient resilience for said separate component (8a) to resume its original shape after use, or sufficient rigidity for its shape to be substantially preserved throughout its entire life cycle. At all events, this porous material does not offer significant resistance to the flow of said product.

As shown particularly in FIG. 1b, said axial rod (4) may be a rod (4a) comprising a head (43a) that centres said rod, so as to be able to eliminate said inner centring component (7).

In this case, as can be seen in FIG. 1b, the head (43a) of said rod (4, 4a) comprises a radial support ring (433) on the upper end of said neck (20), and typically identical in diameter to said neck (20), in such a way that said outer assembly component (6) is able to interlock said rod (4, 4a) axially with said container (2), but without hindering the rotation of said rod (4, 4a) relative to said container (2).

As shown in FIGS. 1i and 1j, said outer assembly component (6) may be an outer assembly component (6a) that interlocks said applicator (8) with said application head (3), so as to be able to eliminate said assembly bush (9). In this latter case, the outer assembly component comprises an upper flange (64) allowing said applicator (8) to be interlocked typically via its lower flange (83).

As shown in FIGS. 1c and 1h, said assembly bush (9) may be an assembly bush (9a) able to interlock said application head (3) with said neck (20) of said container (2), and able to engage in rotation with said head (43a), so as to be able to eliminate said outer assembly component (6).

In this case, the axial rotation engaging projections (12, 12′) may be formed between said assembly ring (9) and said head (43a) as shown in FIG. 1c, or between said assembly bush (9) and said inner part (7), as shown in FIG. 1h.

Furthermore, the axial rotation engaging projections (12, 12′) may be formed between said outer part (6) and said inner part (7), as shown in FIGS. 1a and 1i, or between said outer component (6) and said head (43a, 43d) as shown in FIGS. 1b and 1j.

As shown in FIG. 1c, said head (43, 43a) of said rod (4) may comprise axial projections (430) acting as a stop against said applicator (8), so as to act as a holder for said applicator (8) or for said typically inclined application portion (81) of said applicator (8).

As shown in FIG. 1h, said inner centring component (7) may be an inner centring component (7a) able to engage in rotation with said assembly bush (9), said head (43) being a head (43b) acting as a holder for said applicator (8) or for its topmost part, so as to be able to eliminate said outer assembly component (6).

In this case, said applicator (8) or said typically inclined application portion (81) of said applicator (8) may comprise axial projections (810) acting as a stop against the head (43, 43b) of said rod (4), particularly in the event of such projections being necessary to preserve the shape of said applicator (8) or to act as a holder for the typically inclined application portion (81).

According to another embodiment of the invention, said applicator (8) may form a component (8b) moulded out of a plastic material provided with at least one orifice (80) and typically with a plurality of orifices (80a).

While said separate component (8a), which may also be formed by moulding, is intrinsically porous in respect of said product, said moulded component (8b) is a component of a plastic material which comprises at least one orifice (80) to allow said product to pass through, said plastic material not in itself being porous.

As shown in FIG. 1e, said moulded component (8b) may be a moulded component (8c) comprising a skirt (84) interlocking said moulded component (8c) with said neck (20), so as to be able to eliminate said outer assembly component (6) and said assembly bush (9).

Said axial rod (4) may be a rod (4c) comprising a head (43c) that centres said rod, so as to be able to eliminate said inner centring component (7), as shown in FIG. 1e.

But as shown in FIG. 1f, said applicator (8), or said moulded component (8c), may form with said rod (4) a component cast in one piece (8d), typically provided with an orifice (80).

According to a variant shown in FIG. 1g, said moulded component (8d) may be a moulded component (8d′) engaging, typically by being snapped on, with an application insert (85) comprising said plurality of orifices (80a). In this case, said application insert may also be constituted by said component of porous, alveolar or fibrous material (8a).

However, said applicator (8) may also form a brush, adapted for example to the application of nail varnish, said brush comprising a plurality of hairs typically orientated along said axial direction (10). Thus, according to another variant shown in FIG. 1k, said insert (85) is an insert (85′) acting as a holder for a plurality of hairs (850), so as to form a brush, said dispenser (1) being able to contain, for example, by way of fluid product, nail varnish.

As shown in FIG. 1f, said moulded component (8d) may comprise or form said orifice (80). This single orifice may for example be in the shape of a slit, which may be orientated, for example, in the direction of the slope of the inclined application portion (81), and/or in a crosswise direction, perpendicular to the slope.

Said application head (3) or said applicator (8, 8a, 8b, 8c) may have an outer surface provided with a concavity so as to facilitate application of said cosmetic product to the lips. Such a concavity has been marked on FIGS. 1d to 1g.

According to the invention, said application head (3) may be interlocked with said neck (20) by means of said circular groove (21) and a first shoulder (24) by being snapped on axially.

As shown in FIGS. 1a to 1k, which show closed dispensers (1), said cap (11) may be able to be snapped on or fixed temporarily to said container (2), typically to the neck (20) of said container (2), so as to cover said application head (3), and so as to render any relative rotation of said application head (3) impossible relative to said container (2) when said cap (11) is interlocked with said container (2). To advantage, said cap (11) engages in a sealed away with said container (2).

Typically, said lateral wall (26) of said container (2) may comprise an upper part (27) provided with a peripheral rib (25) intended to allow the cap (11) to be snapped on and forming a second shoulder (28), said cap (11) including a lower end (110) acting typically as a stop against said second shoulder (28), in such a way that said cap is connected to said lateral wall, said lateral wall (26) of said container (2) and said cap (11) being typically of one and the same transverse cross-section.

As shown in FIG. 5, said piston (5) may have a half-section with a U-shaped structure which comprises a threaded inner skirt (51) engaging with said threaded rod is (4), an outer skirt (52) and a connection portion (53) interlocked with the lower ends of the inner (51) and outer (52) skirts, said outer skirt (52) carrying, typically at its lower end, said flexible peripheral lip (50). In said U-shaped structure, the U-shaped base forming said connection portion (53) is placed on the side of said cosmetic product, the inner cavity of the U-shape not being in contact with said cosmetic product.

According to the invention, the ratio of axial heights L_{P}/L_{A} may be comprised between 0.5 and 5, and be typically at least equal to 1.5 and possibly above 2, when said dispenser (1) is filled, said piston (5) then being in the high position, in such a way that said dispenser (1) has a high storage capacity or volume, said axial heights L_{P} and L_{A} corresponding to the axial heights measured along said axial direction (10), L_{P} corresponding to the axial height running from beneath said piston (5) to said bottom (23), so as to express the storage capacity of said dispenser (1), and L_{A} corresponding to the axial height running from the top of said piston (5) as far as the top of the applicator (8), so as to express the axial space requirement of said application head (3).

Said axial heights L_{P} and L_{A} have been shown in FIG. 1a.

As shown in FIGS. 2 and 4, said application head (3) and said neck (20) of said container (2) may engage so as to present an escape, in order that, when said piston (5) descends gradually towards the bottom of said container (2) as said cosmetic product is consumed, said piston (5) is at atmospheric pressure on its rear face not in contact with said cosmetic product. The plurality of axial grooves (200) may also be of use to this end.

According to the invention, said container (2) may be formed of a transparent plastic material. It may thereby be possible to see the contents of said dispenser (1), and particularly the shade of cosmetic product contained in the container (2), or again to assess the quantity of product remaining in the container (2).

### EMBODIMENT EXAMPLES

FIGS. 1a to 13 constitute embodiment examples.

Only the manufacture of the embodiment of the dispenser (1) according to FIG. 1a and according to FIGS. 2 to 13 will be given in detail.

I—Manufacturing the Components of the Dispenser (1)

All the components of this dispenser (1) have been manufactured by moulding thermo-plastic material:

A—The Container (2) Provided with the Neck (20).

It corresponds to that in FIGS. 2 to 4. It may be manufactured typically by injection moulding, or by co-injection moulding, in a relatively rigid plastic material, the lateral wall (26) being able to comprise several layers of different plastic materials. Depending on the cosmetic product contained, it is possible to use thermoplastic materials that form a barrier particularly to oxygen, water vapour or solvents.

The lateral wall or skirt (26) of the container (2) is of typically cylindrical transverse cross-section, but the cross-section could be of any type, providing it remains constant over the full height of the wall (26), so as to allow the displacement of the piston (5) from top to bottom.

The lateral wall (26) contains internally a plurality of axial ribs (260) intended to lock the piston (5) in rotation when the lateral wall (26) is of circular cross-section.

The neck (20) comprises internally axial grooves (200) intended to provide an input of air as the piston descends into said container (2). It comprises a circular groove (21) intended for the application head (23) to be snapped axially onto the neck (20), typically irreversibly, and a shoulder (24), called the “first shoulder”.

The neck (20) includes at least one detent or notch (201) engaging with a complementary element of said application head (3), so as to impose a direction of rotation of said application head (3) relative to the container (2), so that the piston (5) can only descend and that in this way, on the one hand, there can be no inflow of air into said container (2), and that, on the other hand, any rotation leads immediately to said applicator (8) being supplied of cosmetic product.

The upper part (27) of the lateral wall (26) comprises a circular rib (25) and a shoulder (28) called the “second shoulder”, so as to be able to snap the cap, typically in a reversible way, onto the upper end (27) of the dispenser.

All these snap-on actions are obtained by engagement of typically male and female components, with a geometry selected so that the snap-on action is reversible, in other words temporary, or irreversible, in other words permanent.

B—The Axial Rod (4)

The axial rod (4) corresponds to the component shown in FIGS. 8 and 9. It has been obtained by moulding in a relatively rigid plastic material.

C—The Piston (5)

The piston (5) corresponds to the component in FIG. 5. It has been obtained by moulding in a plastic material that is less rigid than that used to manufacture said rod (4) or said container (2).

The piston (5) comprises a threaded inner skirt (51) engaging with the threaded rod (4), an outer skirt (52) comprising a lower flexible or supple thinned down part (50) in order to form a sealed contact between said piston (5) and the inner surface of said lateral wall (26), and a connection portion (53) intended to provide the greater part of the downward thrust applied to said cosmetic product.

D—The Outer Component (6)

Said outer component (6) corresponds to the component in FIG. 6. It was obtained by moulding in a typically rigid plastic material.

It comprises:
an upper part forming an arch (62) provided with orifices (620), intended to be used as a holder for the applicator (8, 8a)
a part (61) comprising internally a succession or plurality of ribs (610) for the purpose of transmitting the rotary motion, by means of said inner component (7), to said axial rod (4),
and a skirt (60), integral with the part (61) via a shoulder (63), carrying on its inner surface a plurality of inner projections (600) to interlock said outer component (6) with the neck (20), and thus said application head (3), while allowing a rotation of said application head (3) relative to said neck (2).

As can be seen in FIG. 7, the large number of orifices (620) guarantees that the entire inner surface of the upper portion (81) of the applicator (8) will still be supplied simultaneously with cosmetic product.

E—The Inner Component (7)

Said inner component (7) corresponds to the component shown in FIGS. 10 to 13. It was obtained by moulding in a typically rigid material.

It comprises:
a lower part (71) intended to act as a stop against the upper end (202) of the neck (20), this lower part (71) and the neck (20) being of identical outer cross-section so as to be interlocked axially by the skirt (60) of the outer component (6),
a median part (72) having a polygonal internal cross-section so as to engage in rotation with a part of the head (43) of said axial rod (4),
and an upper part (70) ribbed externally with teeth or ribs (700) intended to engage with the ribs (610) of said outer component (6).
   F—The Applicator (8)

This applicator (8) is a component (8a) of round transverse cross-section, and of axial cross-section, as shown in FIG. 1 a for example.

This component (8a) comprises an upper portion (81) forming the application surface itself, and a straight portion (82) allowing said component (8a) to be interlocked, by means for example of its lower flange (83), with said outer component (6). To do this, an assembly bush (9) has been used which can be a bush made of metal or plastic material firmly fixed onto said outer component (6), in such a way that any manually induced rotary motion exerted on said assembly bush (9) is transmitted without sliding to said assembly component.

G—The Cap (11)

Caps (11) according to FIG. 1a and according to FIG. 1c have been manufactured.

These caps have been manufactured by moulding of plastic material.

They comprise internally, towards their lower end (110), a snap-on groove (111). The cap (11) according to the embodiment in FIG. 1c comprises an inner projection (112) intended to form a stop for said application head (3), in such a way that, said application head (3) being introduced in said cap (11), this assembly may be snapped onto said container (2) after filling of the latter, simply by exerting an axial pressure on the head (113) of the cap (11).

II—Assembling the Components and Filling the Dispenser (1)

The application head (3) was initially formed according to the procedure as follows: it was introduced into the rod (4) in the inner component (7), in such a way that the rod (4) and said inner component (7) engage in rotation by means of homothetical polygonal cross-sections, the piston (5) was then fixed onto said threaded rod (4), then this assembly (4+5+7) was put into the internally ribbed part (61) of said outer component (6), in such a way that said inner component (7) engages in rotation was said outer component (6). The application component (8a) was then fixed onto said outer component (6), which was done using said typically metal or metal plated assembly bush (9), firmly interlocked with said outer component (6).

An assembly (4+5+6+7+8+9) was thus obtained forming said application head (3). This head (3) may be handled and stored separately. Preferably, this assembly is associated with a cap (11) according to FIG. 1c, so as to form a new assembly (3+11) that can be handled and snapped directly onto the container (2).

The container (2) was then filled, and it was closed up by having this assembly (3+11) snapped onto it axially.

Advantages of the Invention

The invention has a number of advantages
on one hand, it allows a solution to be offered to the problems posed by the packaging of fluid products,
on the other hand, it offers a large number of practical embodiments, so as to allow all kinds of fluid cosmetic products to be packaged, these cosmetic products not being restricted only to lipsticks,
furthermore, in some of these practical embodiments, the dispenser (1) is formed of a restricted number of parts, which makes it particularly advantageous from an economic point of view,
additionally, dispensers (1) according to the invention have a typically higher capacity/total volume ratio than that of prior art dispensers,
finally, the invention makes it possible to have dispensers (1), with transparent containers, of great aesthetic quality.

Furthermore, the invention meets the permanent need to offer users of cosmetic products, forms of packaging that are new but for which no training is needed to use them, nor too great a change relative to the habits of these users.

List of Reference Numbers

Dispenser 1
axial direction/axis of symmetry 10
Cap 11
   Lower end 110
   Snap-on groove with 25 111
   Inner projection 112
   Head of 11 113
Axial rotation engaging projections 12,12′

Longitudinal container 2
Neck of 2 20
   Plurality of axial grooves 200
   Detent—Upper notch 201
   Upper end 202
Circular groove of 20 to fix 3 21
Notch 22
Bottom of 2 23
First shoulder between 20 and 26 for 3 24
Circular rib of 20 for 11 25
Lateral wall or skirt 26
   Axial rib 260
Upper part of 26 27
Second shoulder for 11 28

Application head 3

Axial rod 4,4a,4b
Axial shaft 40
Upper orifice 41
Upper end 42
Head 43,43a,43b
   Axial projections 430
   Upper part of 43 431
   Lower part of 43 432
   Radial ring on 20 433
Hollowed out upper part 44
Lower end 45
Non-threaded part of 4,40 46
Threaded part of 4,40 47

Piston 5
Flexible peripheral lip 50
Threaded inner skirt 51
Outer skirt 52
Connection portion 53

Outer component for assembly with 2 6,6a
Low skirt 60
Inner projections for assembly with 20 600
Part of internally ribbed cross-section 61
   Ribs to engage 7 or 4 610
Upper arch 62
   Orifice or plurality of orifices 620
Shoulder 63
Upper flange for assembly of 8 64

Inner component for centring 4 7,7a
Externally ribbed upper part 70
   Tooth of 7 700
Lower part of 7 71
   Non-return notch 710
Median part of 7 72
   Polygonal cross-section 720

Applicator 8

Component in porous/alveolar/fibrous material 8a

Moulded component 8b,8c,8d
Orifice 80
Plurality of orifices or channels 80a
Application portion (inclined) 81
   Axial projections 810
Straight portion 82
Lower flange 83
Skirt for interlocking 8b with 20 84
Application insert 85,85′
   Plurality of hairs 850
Inner projections for assembly with 20 86

Bush for assembly of 8 with 6 9,9a
Reflex flange 90
Inner projections for assembly with 20 91

1. Dispenser of fluid cosmetic products (1), intended particularly for the packaging of cosmetic products for application to the lips, comprising a body forming a longitudinal container (2) intended to contain said product comprising a lateral wall (26) of constant internal cross-section having an axial direction (10) and an opening in its upper part typically forming a neck (20), an application head (3) closing up said upper opening able to apply said product, a typically threaded axial rod (4) engaging with a piston (5) able to be displaced axially in said container (2) by rotation of said rod (4), and a cap (11) to cover said application head (3) when said dispenser (1) is said to be closed, characterised in that:
a) said rod (4) is a hollow rod forming an axial shaft (40) allowing said product to flow from the bottom of said container (2) up to said application head (3), said hollow rod (4) emerging through an upper orifice (41) at its upper end (42) onto said application head (3),
b) said axial rod (4) engages in rotation with said application head (3), in such a way that a relative manual rotation of said application head (3) relative to said container (2) brings about a displacement of said piston (5) towards the bottom of said container (2), compresses said fluid cosmetic product and allows it to flow in said axial shaft (40) up to said application head (3) so that said application head (3) is supplied with cosmetic product, and so as to have a mechanism for propelling said product that has a small space requirement and is partly housed in said application head (3).

2. Dispenser according to claim 1, wherein said application head (3) comprises:
a) an outer component (6) for assembly with said container, typically able to engage said rod (4) in rotation,
b) an inner component (7) for centring said rod (4),
c) an applicator (8) closing up said upper orifice (41) of said rod(4),
d) a bush (9) for assembling said applicator (8) with said outer component (6), in such a way that said manual rotation applied to said bush (9) engages that of said rod (4).

3. Dispenser according to claim 2, wherein said neck (20) of said container (2) comprises a circular groove (21) providing an axial coupling of said outer component (6), or of said applicator (8), or of said bush (9) of said application head (3) with said neck (20), said outer component (6), or said applicator (8), or said bush (9) comprising a plurality of inner projections, denoted respectively (600), (86) (91), intended to be snapped into said circular groove (21).

4. Dispenser according to claim 2, wherein said outer component (6) comprises a part of internally ribbed cross-section (61) engaging in rotation along said axial direction (10) with a part of externally ribbed cross-section (70) of said centring component (7).

5. Dispenser according to claim 1, wherein said centring component (7) comprises on its lower part (71) a tooth or non-return notch (710) intended to engage with a notch (22) formed on the opening of said container (2), in such a way that said application head (3) is only able to rotate relative to said container (2) in the sole direction of rotation that allows the piston (5) to descend in said container (2).

6. Dispenser according to any one claim 2, wherein said centering component (7) comprises a median part (72) of polygonal internal cross-section (720), said threaded rod (4) being provided with a head (43) comprising a part of identical polygonal cross-section, so as to interlock said threaded rod (4) in rotation with said centering component (7).

7. Dispenser according to claim 1, wherein said assembly component (6) has a tubular configuration with an upper arch (62) provided with a plurality of orifices (620) communicating with said applicator (8), said threaded rod (4) comprising a hollowed out upper part (44), in such a way that said cosmetic product is able to flow to the outlet of said axial shaft (40) as far as said plurality of orifices (620).

8. Dispenser according to claim 1, wherein said threaded rod (4) has a sufficient distance between its lower end (45) and the bottom (23) of said container (2) to bring the inside of said container (2) and the inside of said axial shaft (40) into communication.

9. Dispenser according to claim 8, wherein said threaded rod (4) comprises at its lower end (45) a non-threaded part (46), so as to prevent said piston (5) from being compressed against said bottom (23) of said container (2).

10. Dispenser according to claim 1, wherein said container (2) comprises an anti-rotation means, typically formed by a plurality of axial ribs (260) formed on the inner surface of said wall (26) of said container (2), engaging with said piston (5), so as to interlock said container (2) and said piston (5) in rotation.

11. Dispenser according to claim 1, wherein said piston (5) comprises a flexible peripheral lip (50) so as to provide a sealed joint with the inner surface of said container (2).

12. Dispenser according to any one of claims 2 to 10, wherein said neck (20) comprises on its inner surface a plurality of axial grooves (200) so as to provide an evacuation of air during an assembly of said application head (3) or of said mechanism with said container (2) previously filled with said cosmetic product, said piston (5) having previously been screwed to said threaded rod (4).

13. Dispenser according to claim 2, wherein said neck (20) comprises on its inner surface a plurality of axial grooves (200) so as to provide an evacuation of air during an assembly of said application head (3) or of said mechanism with said container (2) previously filled with said cosmetic product, said piston (5) having previously been screwed to said threaded rod (4).

14. Dispenser according to claim 2, wherein said applicator (8) comprises a typically inclined application portion (81) forming a surface for the application of said cosmetic product and a straight portion (82) possibly comprising a lower assembly flange (83), in such a way that said applicator (8) is integral with said application head (3), for example, by means of a reflex flange (90) of said assembly bush (9).

15. Dispenser according to claim 2, wherein said applicator (8) forms a separate component (8a) in a porous or fibrous or alveolar material with open alveoli.

16. Dispenser according to claim 14, wherein said axial rod (4) is a rod (4a) comprising a head (43a) that centers said rod, so as to be able to eliminate said inner centering component (7).

17. Dispenser according to claim 14, wherein said outer assembly component (6) is an outer assembly component (6a) interlocking said applicator (8) with said application head (3), so as to be able to eliminate said assembly bush (9).

18. Dispenser according to claim 15, wherein said assembly bush (9) is an assembly bush (9a) able to interlock said application head (3) with said neck (20) of said container (2), and able to engage in rotation with said head (43a), so as to be able to eliminate said outer assembly component (6).

19. Dispenser according to claim 17, wherein said head (43, 43a) of said rod (4) comprises axial projections (430) acting as a stop against said applicator (8), so as to act as a holder for said applicator (8) or for said typically inclined application portion (81) of said applicator (8).

20. Dispenser according to claim 14, wherein said inner centering component (7) is an inner centering component (7a) able to engage in rotation with said assembly bush (9), said head (43) being a head (43b) acting as a holder for said applicator (8) or for its topmost part, so as to be able to eliminate said outer assembly component (6).

21. Dispenser according to claim 19, wherein said applicator (8) or said typically inclined application portion (81) of said applicator (8) comprises axial projections (810) acting as a stop against the head (43, 43b) of said rod (4).

22. Dispenser according to claim 2, wherein said applicator (8) forms a molded component (8b) in a plastic material provided with at least one orifice (80) and typically with a plurality of orifices (80a).

23. Dispenser according to claim 21, wherein said applicator (8) or said molded component (8b) is a molded component (8c) comprising a skirt (84) interlocking said molded component (8c) with said neck (20), so as to be able to eliminate said outer assembly component (6) and said assembly bush (9).

24. Dispenser according to claim 22, wherein said axial rod (4) is a rod (4c) comprising a head (43c) that centers said rod, so as to be able to eliminate said inner centering component (7).

25. Dispenser according to claim 23, wherein said applicator (8), or said molded component (8c), forms with said rod (4) a component cast in one piece (8d), typically provided with an orifice (80).

26. Dispenser according to claim 24, wherein said molded component (8d) is a molded component (8d′) engaging, typically by being snapped on, with an application insert (85) comprising said plurality of orifices (80a).

27. Dispenser according to claim 24 wherein said molded component (8d) comprises or forms said orifice (80).

28. Dispenser according to claim 1, wherein said application head (3) or said applicator (8, 8a, 8b, 8c) has an outer surface provided with a concavity so as to facilitate application of said cosmetic product to the lips.

29. Dispenser according to claim 1, wherein said application head (3) is interlocked with said neck (20) by means of said circular groove (21) and of a first shoulder (24) by being snapped on.

30. Dispenser according to claim 1, characterised in that said cap (11) is able to be snapped on or fixed temporarily to said container (2), typically to the neck (20) of said container (2), so as to cover said application head (3), and so as to render any relative rotation of said application head (3) impossible relative to said container (2) when said cap (11) is interlocked with said container (2).

31. Dispenser according to claim 29 wherein said lateral wall (26) comprises an upper part (27) provided with a peripheral rib (25) intended to allow the cap (11) to be snapped on and forming a second shoulder (28), said cap (11) including a lower end (110) acting typically as a stop against said second shoulder (28), in such a way that said cap is connected to said lateral wall, said lateral wall (26) of said container (2) and said cap (11) being typically of one and the same transverse cross-section.

32. Dispenser according to claim 1 wherein said piston (5) has a half-section with a U-shaped structure which comprises a threaded inner skirt (51) engaging with said threaded rod (4), an outer skirt (52) and a connection portion (53) interlocked with the lower ends of the inner (51) and outer (52) skirts, said outer skirt (52) carrying, typically at its lower end, said flexible peripheral lip (50).

33. Dispenser according to claim 1, wherein the ratio of axial heights L_{P}/L_{A} is comprised between 0.5 and 5, and is typically at least equal to 1.5 and possibly above 2, when said dispenser is filled, in such a way that said dispenser has a high storage capacity or volume, said axial heights L_{P} and L_{A} corresponding to the axial heights measured along said axial direction (10), L_{P} corresponding to the axial height running from beneath said piston (5) to said bottom (23), so as to express the storage capacity of said dispenser (1), and L_{A} corresponding to the axial height running from the top of said piston (5) as far as the top of the applicator (8), so as to express the axial space requirement of said application head (3).

34. Dispenser according to claim 1, wherein said application head (3) and said neck (20) of said container (2) engage so as to present an escape, in order that, when said piston (5) descends gradually towards the bottom of said container (2) as said cosmetic product is consumed, said piston (5) is at atmospheric pressure on its rear face not in contact with said cosmetic product.

35. Dispenser according to claim 1, wherein said container (2) is formed of a transparent plastic material.
